(19) United States
(12) Patent Application Publication
(10) Pub. No.: US 2025/0390378 A1
(43) Pub. Date: Dec. 25, 2025

(54) DATA BUS INVERSION WITH SHARED CRC AND DATA TRANSFER TECHNIQUES BY DETERMINISTIC CRC ERROR INJECTION

(71) Applicant: Intel Corporation, Santa Clara, CA (US)

(72) Inventors: Vinod INIPODU MURUGAN, Bangalore (IN); Raju Kothandaraman KASTURI, Folsom, CA (US)

(21) Appl. No.: 19/313,934

(22) Filed: Aug. 29, 2025

(51) Int. Cl. G06F 11/10

(52) U.S. Cl. CPC G06F 11/1004

(57) ABSTRACT

Disclosed herein is transmission and reception scheme for communicating data over a data bus and determining errors in the communicated data. The system includes a transmitter circuitry and a receiver circuitry. The transmitter circuitry generates a CRC code based on an input data word, encodes the input data word with a data-bus inversion (DBI) vector, and transmits the DBI-encoded data word along with the CRC code to the receiver circuitry. The receiver circuitry decodes, over a plurality of candidate DBI vectors, the DBI-encoded data word based on each candidate DBI vector, computes an associated CRC value for each candidate data word, and determines a reconstructed input data word based on which associated CRC value of the plurality of candidate data words matches the CRC code.

### BACKGROUND

Advancements in memory technology continue to emphasize reduced form factors, lower power consumption, and cost efficiency, without sacrificing performance. To support these goals, modern very-large-scale integration (VLSI) designs aim to incorporate enhanced features while minimizing the number of physical input/output (I/O) pins.

Conventional SDRAM (synchronous dynamic random-access memory) specifications often include error detection mechanisms, such as cyclic redundancy check (CRC), to improve system reliability. Likewise, data bus inversion (DBI) is commonly used to reduce I/O power consumption. Both CRC and DBI functions typically require dedicated physical pins for transmission of their respective information. As a result, current memory interface protocols often rely on two separate sets of pins-one set of pins for CRC (e.g., 8 per byte lane) and one set pins for DBI (e.g., one per byte lane)—thereby increasing pin count despite efforts to reduce it. In addition, data buses (e.g., DQ lines) are often limited by pin count, limiting the data bits sent over the data bus to a fixed bitlength, so there are limits to the amount of data that may be transferred over a fixed bitlength data bus.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example plot of error detection efficiency for a conventional CRC scheme that uses a CRC8 polynomial;

FIG. 2 illustrates an example of a system for communicating data that may be DBI encoded, where the DBI information and CRC information need not be signaled separately;

FIG. 3 depicts an example of a system for communicating data and along with the normal payload, additional data bits that may be embedded in data and CRC information;

FIG. 4 shows an example graph that plots error detection efficiency for a CRC and DBI encoding scheme, where the DBI information and CRC information are not signaled separately;

FIG. 5 illustrates an example graph that plots error detection efficiency for a conventional CRC8 polynomial scheme along side a plot of the error detection efficiency for a modified CRC8 polynomial scheme that provides for transmission of an additional data bit; and

FIG. 6 shows an example graph that plots error detection efficiency for a conventional CRC8 polynomial scheme along side a plot of the error detection efficiency for modified CRC8 polynomial schemes that provide for transmission of 1, 2, and 3 additional data bits respectively;

FIG. 7 shows an example graph that plots error detection efficiency for a conventional CRC8 polynomial scheme along side a plot of the error detection efficiency for modified CRC8 polynomial schemes that provide for transmission of 4, 5, and 6 additional data bits respectively; and

FIG. 8 depicts an example flow diagram for a method of communicating data over a data bus using a CRC and DBI encoding scheme, where the DBI information and CRC information are not signaled separately.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As noted above, CRC and DBI functions typically require dedicated sets of physical pins to transmit information about the CRC and DBI (typically, per byte lane, 8 pins for CRC and 1 pin for DBI). Disclosed in more detail below is combined CRC and DBI approach, whereby both CRC information and DBI information may be transmitted without requiring two separate sets of pins. The disclosed encoding scheme encodes/decodes CRC and DBI data by compressing them onto a single set of pins (e.g., per byte lane an 8 bit set of CRC pins without the need for a separate, corresponding DBI pin for the byte lane) without compromising performance. In addition, a modified CRC approach is disclosed that enables sending additional data bits by encoding the additional data bits into the CRC. This allows transfer of additional data bits without requiring a larger data bus (i.e., without requiring additional data (DQ) pins). An additional bit for data transfer may be provided by encoding the extra bit of data into the data lines (DQ) and its corresponding CRC packets. For example, when a data word has a bitlength of 64 (D[0:63]), each byte lane has a corresponding 8 bit CRC (CRC[0:7]). Thus, up to 7 bits of additional data may be embedded within the same number of pins for a 64-bit data word while maintaining error detection accuracy. While a 64 bit data word is used throughout as an example, the same scheme may be applied to wider or narrower data buses.

In conventional memory systems, both DBI and CRC have been widely adopted to enhance data integrity and reduce power consumption during data transfers between the system-on-chip (SoC) and DRAM. CRC is employed to check for transmission errors while DBI is helpful for lowering I/O power consumption by reducing the number of data lines driving a low logic level. The drawback has been that employing DBI with CRC required, per byte lane, a dedicated set of pins for CRC as well as a separate, dedicate pin for DBI.

For example, in GDDR6 memory, a checksum may be generated per byte lane for both read and write operations. The 16-bit CRC code is computed over a 16-bit burst in two halves: the lower 8 bits (CRC-L) are calculated from burst positions 0-7, and the upper 8 bits (CRC-U) from burst positions 8-15. The memory device returns this checksum to the controller, which verifies data integrity and may reissue the READ or WRITE command if a CRC error is detected. Memories may use an 8-bit CRC computed, for example, over 72 bits of data using a fixed polynomial (0×83 or X⁸+X²+X+1), with a hardware-defined seed value of zero. To transmit the CRC code alongside the data, a dedicated set of CRC pins is typically implemented on the SoC. Generally, adding CRC support is a computationally efficient way to help ensure data integrity during transmission and storage and it is a particularly effective error detection method for detecting burst errors. The result is a compact, 8-bit signature that represents the integrity of the 72-bit data word. This CRC value is then transmitted alongside the data to allow the receiving device to verify correctness.

For example, for a 72-bit data word (e.g., 64 data word with an 8 bit error correction code (ECC)), an 8-bit CRC checksum may be computed to support error detection. Each bit of the CRC output may be generated by applying a predefined XOR pattern over a selected subset of the 72 data bits. The specific combination of bits involved in the XOR for each CRC output bit is fixed and based on a chosen polynomial, commonly used in memory interface standards such as GDDR6. The process involves evaluating each CRC bit (CRC[0] through CRC[7]) as the exclusive-OR (XOR) of certain data bits from the input word. This ensures that each CRC bit captures a unique pattern of the original data, maximizing the likelihood of detecting bit errors.

For instance, CRC[0] may derived from the XOR of a first set of bits such as D[69], D[68], D[67], D[66], D[64], D[63], D[60], D[56], D[54], D[53], D[52], D[50], D[49], D[48], D[45], D[43], D[40], D[39], D[35], D[34], D[31], D[30], D[28], D[23], D[21], D[19], D[18], D[16], D[14], D[12], D[8], D[7], D[6], and D[0], while CRC[1] uses a different, specific combination of bits, such as D[70], D[66], D[65], D[63], D[61], D[60], D[57], D[56], D[55], D[52], D[51], D[48], D[46], D[45], D[44], D[43], D[41], D[39], D[36], D[34], D[32], D[30], D[29], D[28], D[24], D[23], D[22], D[21], D[20], D[18], D[17], D[16], D[15], D[14], D[13], D[12], D[9], D[6], D[1], and D[0]. This ensures that each CRC bit captures a unique pattern of the original data, maximizing the likelihood of detecting bit errors.

Expanding on this example for further XOR combinations of bits, CRC[2] may be the XOR of the combination of D[71], D[69], D[68], D[63], D[62], D[61], D[60], D[58], D[57], D[54], D[50], D[48], D[47], D[46], D[44], D[43], D[42], D[39], D[37], D[34], D[33], D[29], D[28], D[25], D[24], D[22], D[17], D[15], D[13], D[12], D[10], D[8], D[6], D[2], D[1], and D[0]. CRC[3] may be the XOR of the combination of D[70], D[69], D[64], D[63], D[62], D[61], D[59], D[58], D[55], D[51], D[49], D[48], D[47], D[45], D[44], D[43], D[40], D[38], D[35], D[34], D[30], D[29], D[26], D[25], D[23], D[18], D[16], D[14], D[13], D[11], D[9], D[7], D[3], D[2], and D[1]. CRC[4] may be the XOR of the combination of D[71], D[70], D[65], D[64], D[63], D[62], D[60], D[59], D[56], D[52], D[50], D[49], D[48], D[46], D[45], D[44], D[41], D[39], D[36], D[35], D[31], D[30], D[27], D[26], D[24], D[19], D[17], D[15], D[14], D[12], D[10], D[8], D[4], D[3], and D[2].

CRC[5] may be the XOR of the combination of D[71], D[66], D[65], D[64], D[63], D[61], D[60], D[57], D[53], D[51], D[50], D[49], D[47], D[46], D[45], D[42], D[40], D[37], D[36], D[32], D[31], D[28], D[27], D[25], D[20], D[18], D[16], D[15], D[13], D[11], D[9], D[5], D[4], and D[3]. CRC[6] may be the XOR of the combination of D[67], D[66], D[65], D[64], D[62], D[61], D[58], D[54], D[52], D[51], D[50], D[48], D[47], D[46], D[43], D[41], D[38], D[37], D[33], D[32], D[29], D[28], D[26], D[21], D[19], D[17], D[16], D[14], D[12], D[10], D[6], D[5], and D[4]. CRC[7] may be the XOR of the combination of D[68], D[67], D[66], D[65], D[63], D[62], D[59], D[55], D[53], D[52], D[51], D[49], D[48], D[47], D[44], D[42], D[39], D[38], D[34], D[33], D[30], D[29], D[27], D[22], D[20], D[18], D[17], D[15], D[13], D[11], D[7], D[6], and D[5]. The result is a compact, 8-bit signature that represents the integrity of the 72-bit data word. This CRC value is then transmitted alongside the data to allow the receiving device to verify correctness.

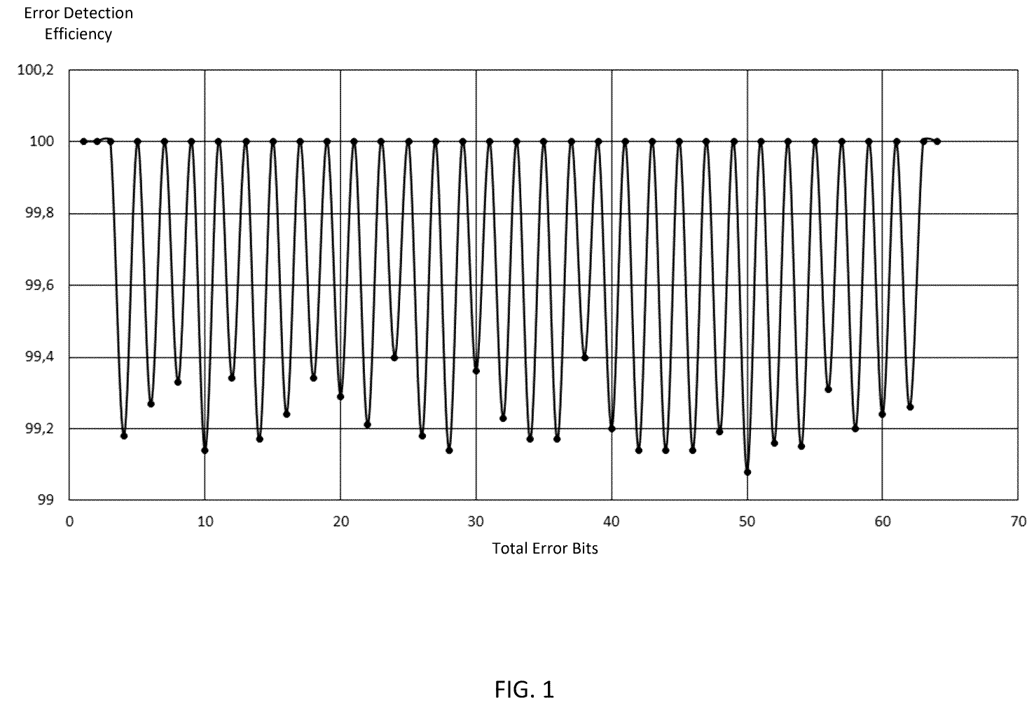

According to the CRC definitions above, FIG. 1 shows the error detection efficiency on the y-axis over different numbers of total error bits on the x-axis. As can be seen, the accuracy for the above CRC8 polynomial across different error bits is 100% for all odd bit errors and for even bit errors, the error detection efficiency drops to ˜99.2%.

With respect to DBI, DBI is evaluated per byte, with one DBI signal per byte group. For instance, DBI0_n corresponds to DQ[7:0], and DBI1_n to DQ[15:8]. A dedicated DBI pin is also implemented on the SoC to carry this information, one pin per byte group. Thus, conventional designs require dedicated sets of physical pins to implement DBI and CRC for corresponding DQ data lines. Generally, the DBI coding technique is often used to reduce power consumption in data movement by inverting the data on the bus based on a majority function, which helps to minimize transitions and thus reduce dynamic power dissipation. In some cases, utilizing DBI may lead to a ˜30% improvement in power consumption and a ˜5% improvement to I/O margins.

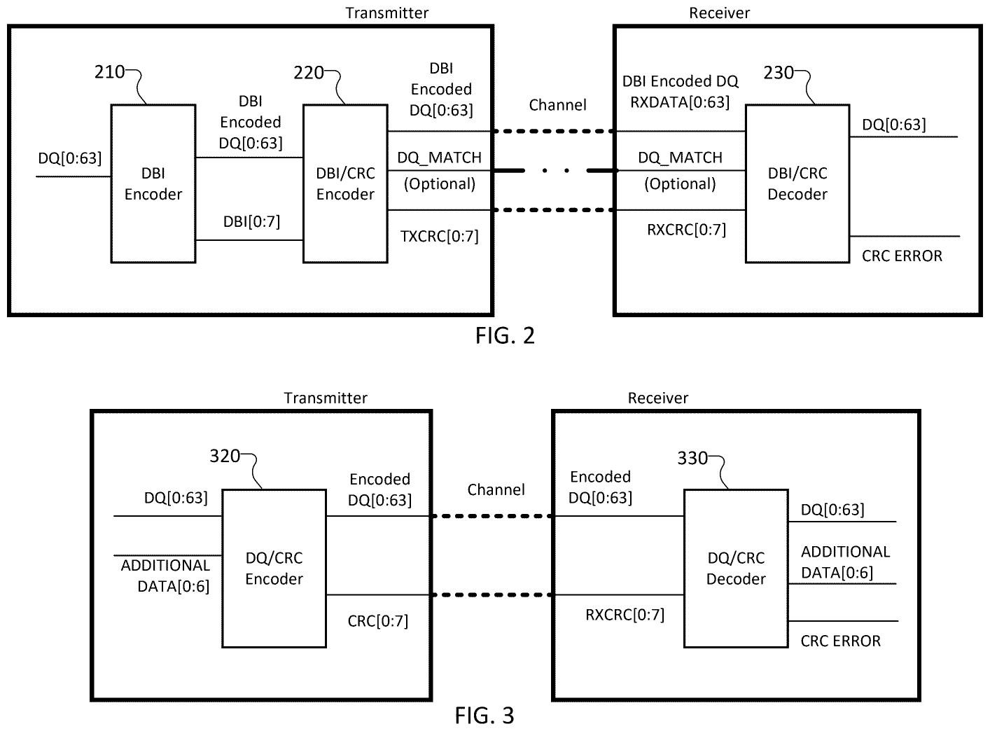

Unlike the dedicated-pin approach, disclosed herein is an improved encoding/decoding scheme where CRC and DBI data may be encoded/decoded by compressing them together, without needing dedicate pins each for CRC and separately for DBI, and without compromising performance. This means that DBI data need not be transmitted on a separate pin and may instead be embedded in the corresponding CRC information. One advantage of the disclosed approach is the elimination of one high speed signal pin (per byte) that would otherwise be needed to send DBI information, which may assist in keeping form factors small while also providing the improved power consumption advantages of DBI. Certain memory protocols (like high bandwidth memory (HBM) or double-data rate (DDR)) that currently only support DBI and do not have a dedicated CRC physical pin may advantageously offer both DBI and CRC together over the same pin to provide the benefits of DBI with CRC, without the need to dedicate a physical pin to CRC. The encoder and decoder logic may reside in the transmit and receive blocks, respectively, and the receiver may correctly decode the DQ payload (without separately signaling the DBI information) by looking into the information compressed onto the CRC pin(s) along with the DBI-encoded channel data. This aspect is discussed in more detail below with respect to FIG. 2.

A separate feature and further advantage is that additional data bits may be encoding the data into DQ/CRC packets to allow for additional bit(s) of high speed data transfer (e.g., up to 7 bits in a 64 bit data bus with an 8-bit CRC per byte lane), which may assist in keeping form factors small while also providing the ability to transfer additional high speed data bits over the same bus size. In this case, the receive block may correctly decode the DQ payload and additional bit data by looking into the compressed data transmitted on the DQ and CRC pins for the channel. This aspect is discussed in more detail below with respect to FIG. 3. This additional data bit encoding may be used independent of or in conjunction with the DBI compression feature discussed above for embedding the DBI information without having to separately transmit the DBI information.

Referring to FIG. 2, an example of a system for communicating data over a data channel is shown, where a transmitter (also referred to as transmitter circuitry) encodes data and transmits it to a receiver (also called receiver circuitry) that decodes the data for further processing. Such a system may be utilized in a memory for reading and writing data over a data bus to ensure that data is transmitted error free and efficiently. The system may be used, for example, in memories that utilize various protocols, such as double data rate (DDR), GDDR6, dynamic random-access memory (DRAM), SDRAM, HBM, etc.

On the transmitter side, the CRC is computed (e.g., in DBI/CRC encoder 220) based on the original payload data (DQ) that is to be transmitted: Using a 64-bit word as an example (D[0:63] bits) and the above-described CRC polynomial 8 encoding, the system may determine the 8-bit CRC (as CRC[0:7]) based on the original payload, as shown in the bit position table below, where DQn represents the corresponding byte lane and the Original DQ Data columns show the corresponding bit position in the data word:

Original DQ Data

| | | | | | | | | |
|---|---|---|---|---|---|---|---|---|
| DQ0 | 0 | 1 | 2 | 3 | 4 | 5 | 6 | 7 |
| DQ1 | 8 | 9 | 10 | 11 | 12 | 13 | 14 | 15 |
| DQ2 | 16 | 17 | 18 | 19 | 20 | 21 | 22 | 23 |
| DQ3 | 24 | 25 | 26 | 27 | 28 | 29 | 30 | 31 |
| DQ4 | 32 | 33 | 34 | 35 | 36 | 37 | 38 | 39 |
| DQ5 | 40 | 41 | 42 | 43 | 44 | 45 | 46 | 47 |
| DQ6 | 48 | 49 | 50 | 51 | 52 | 53 | 54 | 55 |
| DQ7 | 56 | 57 | 58 | 59 | 60 | 61 | 62 | 63 |
| CRC | 0 | 1 | 2 | 3 | 4 | 5 | 6 | 7 |

Next, the payload is DBI encoded (e.g., by DBI/CRC encoder 210) to arrive at an DBI-encoded version of the payload (D_DBI[0:63]), which also generates a DBI information codeword (DBI[0:7]). Thus, D_DBI[0:63], DBI[0:7]=DBI_ENCODER(D[0:63])

| | DBI Encoded DQ Data | | | | | | | |
|---|---|---|---|---|---|---|---|---|
| DQ0 | D0 | D1 | D2 | D3 | D4 | D5 | D6 | D7 |
| DQ1 | D8 | D9 | D10 | D11 | D12 | D13 | D14 | D15 |
| DQ2 | D16 | D17 | D18 | D19 | D20 | D21 | D22 | D23 |
| DQ3 | D24 | D25 | D26 | D27 | D28 | D29 | D30 | D31 |
| DQ4 | D32 | D33 | D34 | D35 | D36 | D37 | D38 | D39 |
| DQ5 | D40 | D41 | D42 | D43 | D44 | D45 | D46 | D47 |
| DQ6 | D48 | D49 | D50 | D51 | D52 | D53 | D54 | D55 |
| DQ7 | D56 | D57 | D58 | D59 | D60 | D61 | D62 | D63 |

The DBI information (DBI[0:7]) may be discarded and the transmitter need only transmit the computed CRC values (TXCRC[0:7], which, as noted above are based on the original DQ data, DQ[0:63]) and the DBI-encoded payload (D_DBI[0:63]) to the receiver (e.g., from DBI/CRC encoder 220). Optionally, as will be discussed later, a signal may be sent (e.g., via the command path or other means) to the receiver to identify one of two possible data values that will match during decoding at the receiver. In lieu of such a signal, the DBI/CRC encoder 220 may introduce a deterministic memory “error” (disambiguation value) in the CRC signature such that the identity of the match bit is embedded in the TXCRC[0:7] values sent to the receiver.

On the receiver side, the receiver circuitry receives only the transmitted CRC values (RXCRC[0:7]) and the DBI-encoded payload (D_DBI[0:63]) (and optionally the match bit, DQ_MATCH), and from this information (without knowing the DBI information) may decode the DBI and verify the CRC (e.g., in the DBI/CRC decoder 230). In the example where the DBI is an 8 bit data packet (DBI[0:7]), its value is between 0 and 255. So, the receiver may iterate decoding the received DBI-encoded payload (RXDATA[0:63]) over all possible values of the DBI (i.e. from zero to 255). Then, for each decoded payload value (DQ[0:63]), the receiver may compute the corresponding 8-bit CRC (C_CRC[0:7]). The receiver may then determine for which DBI iteration(s) the received CRC value (RXCRC[0:7]) matches the receiver-computed CRC value (C_CRC[0:7]). Example pseudocode for this sweep is shown below:

For loop on possible DBI[0:7] values from 0 to 255 in steps of 1:

```
  DBI[0:7] = current loop value
  DQ[0:63] = DBI_DECODER(RXDATA[0:63], DBI[0:7])
  C_CRC[0:7] = CRC_COMPUTE(DQ[0:63])
  If(CRC[0:7]==RXCRC[0:7]) then
    Match: Correct RX Data should be current DQ[0:63]
  End If
Next Increment of DBI[0:7]
```

While iterating from DBI values 0 to 255, there should be two instances where the computed CRC matches the received CRC data. (If more than two instances or only one instance is detected during the sweep, this is an indication of error.) To determine which of the two DBI values should be used to decode the payload into the DQ data, the DQ_MATCH indicator may be used. For example, if the DQ_MATCH bit has value of is 0, then the decoded DQ data may be the first matched instance. If the DQ_MATCH bit is 1, then the decoded DQ data may be the second matched instance. The DQ_MATCH bit value may be sent to the receiver on a separate pin, over the command bus, etc.

In lieu of signaling the DQ_MATCH on a separate pin or over the command bus, the DQ/CRC encoder 220 may introduce a deterministic memory “error” in the CRC signature (also called a disambiguation indicator) such that the match bit is embedded in the TXCRC[0:7] values sent to the receiver. Thus, after computing the CRC values on the original DQ data, one bit of the CRC may be intentionally inverted (e.g., a predefined “error” or disambiguation indicator introduced into a bit used to calculate one or more CRC value(s)). For example, when calculating the CRC values, bit D[63] may be inverted based on the DQ_MATCH value, so if DQ_MATCH is 1, then D[63] is inverted and if DQ_MATCH is 0, the original value of D[63] remains the same. The CRC value is then computed based on these intentionally modified bit(s).

In the table below, for example, bit 63 of the original DQ data has been replaced with 63*, which is an inverted version of bit 63 based on DQ_MATCH being 1 and left alone if DQ_MATCH is 0. Thus, D63*32 D63\hat{ }DQ_MATCH.

Original DQ Data, DQ_MATCH Inverted

| | | | | | | | | |
|---|---|---|---|---|---|---|---|---|
| DQ0 | 0 | 1 | 2 | 3 | 4 | 5 | 6 | 7 |
| DQ1 | 8 | 9 | 10 | 11 | 12 | 13 | 14 | 15 |
| DQ2 | 16 | 17 | 18 | 19 | 20 | 21 | 22 | 23 |
| DQ3 | 24 | 25 | 26 | 27 | 28 | 29 | 30 | 31 |
| DQ4 | 32 | 33 | 34 | 35 | 36 | 37 | 38 | 39 |
| DQ5 | 40 | 41 | 42 | 43 | 44 | 45 | 46 | 47 |
| DQ6 | 48 | 49 | 50 | 51 | 52 | 53 | 54 | 55 |
| DQ7 | 56 | 57 | 58 | 59 | 60 | 61 | 62 | 63* |
| CRC | 0 | 1 | 2 | 3 | 4 | 5 | 6 | 7 |

As should be appreciated, while bit position 63 is a beneficial bit to select for the predefined inversion because as an odd bit, when CRC polynomial-8 computations, it may have lower impact to compromising error detection efficiency, this bit position is merely exemplary. As should be appreciated, any bit position or combination of bits may be selected as the disambiguation indicator and may depend on the CRC scheme used by the transmitter circuitry to generate the CRC.

This new CRC[0:7] data (which includes a predefined “error” in the CRC based on the DQ_MATCH identifier) are the CRC values that are sent as TXCRC[0:7] to the receiver. On the receiver side, the receiver circuitry (e.g., at DBI/CRC decoder 230) may use the “error” in the computed CRC to identify the which of the two matching instances over the DBI sweep to select as the corresponding DQ data. To do this, two CRC codes may be computed for each instance of the DBI-decoded data during the sweep (e.g., C0_CRC[0:7] and C1_CRC[0:7]), where one computed CRC value is calculated after inverting the bit position of the DBI-decoded data on which the DQ_MATCH was encoded (e.g., bit 63 in the example above) and the other computed CRC value is calculated on the as-DBI-decoded data (without inverting). Now, the correct instance of DBI-decoded data may be selected based on which of the two computed CRC values matches the received CRC data (RXCRC[0:7]).

In terms of the example above, where it sweeps through all 256 possible DBI values to obtain, for each iteration, DBI_DECODED_DQ_DATA[0:63]. For each DBI_DECODED_DQ_DATA[0:63] the DBI/CRC decoder 230 may compute two CRC signatures, C0_CRC[0:7] for DBI_DECODED_DQ_DATA[0:63] and C1_CRC[0:7] for DBI DECODED DQ DATA[0:63*], where D[63] has been inverted from its originally decoded value.

Each of the two CRC signatures are compared with the received RXCRC[0:7] values and if there is a hit, the respective DBI_DECODED_DQ_DATA is captured. There should be two instances where a hit and both instances may then be reviewed to determine which corresponds to the actual data. (If more than two instance or only one instance is detected, this is an indication of error.) To decode the DQ_MATCH signal information, if the RXCRC[0:7] matches C0_CRC[0:7] signature then DQ_MATCH=0, otherwise if RXCRC[0:7] matches C1_CRC[0:7], then the DQ_MATCH=1 or there is an error. After determining the decoded DQ_MATCH value, the correct instance from the two DBI_DECODED_DQ_DATA may be selected as the correct DECODED DQ DATA.

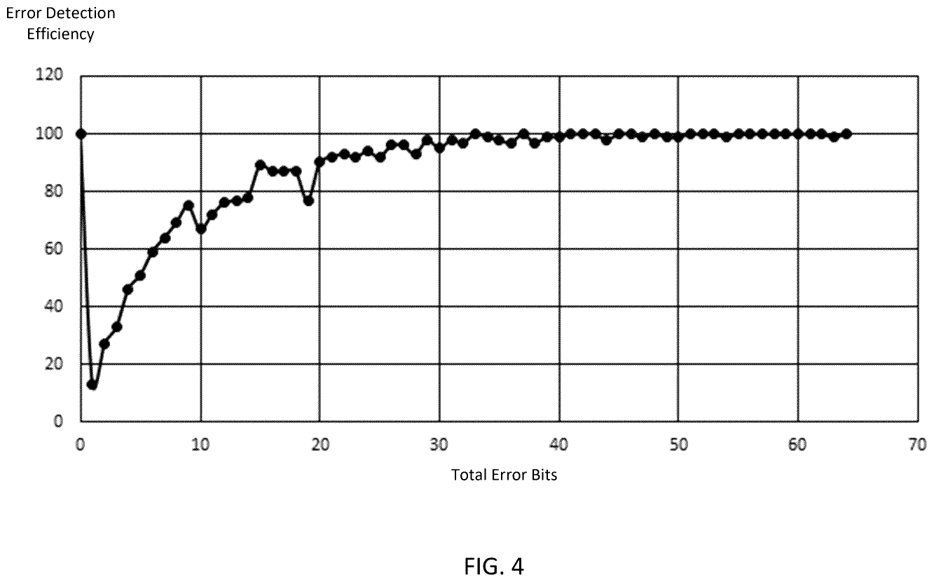

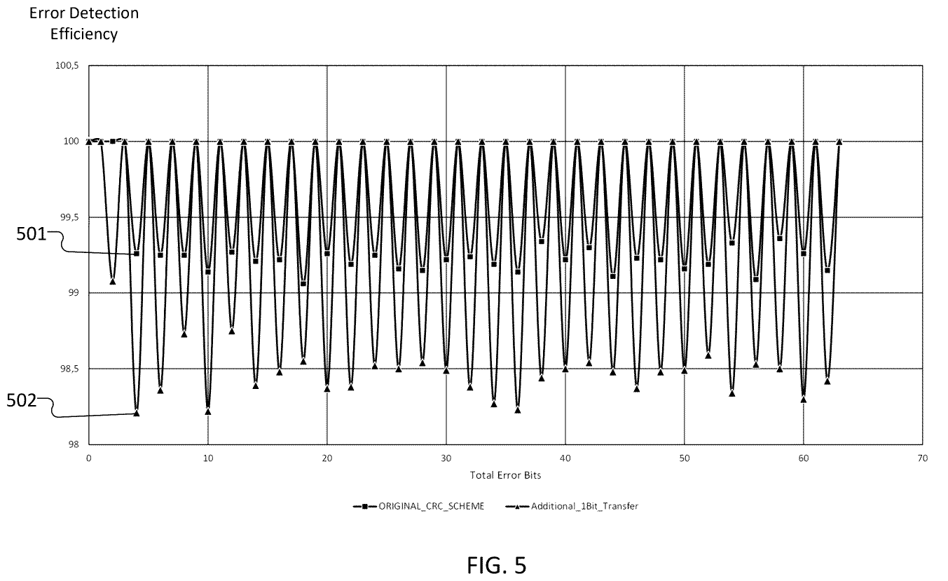

As should be understood, because one of the bits is encoded with the DQ_MATCH data, the ability to recognize an error (e.g., error detection efficiency) is slightly reduced. Nevertheless, the error detection remains robust, especially for a high number of errors. And support for both DBI and CRC may be provided without the need for separate pins to signal DBI and CRC. An example of a plot of the error detection efficiency when encoding the DQ_MATCH data in the CRC values is shown in FIG. 4. When compared to FIG. 1, where only CRC error detection is used, as may be seen in FIG. 4, a scheme that combines CRC and DBI, even without separate signaling, provides significant error detection efficiency.

Separate from or in addition to the above scheme for combining CRC and DBI without the need for separate signaling, discussed below is a system for transmitting additional payload data (e.g., additional bits of payload data) without needing to expand the number of DQ lines, depending on the widths of the DQ lines and corresponding CRC lines. In a system with a 64-bit payload width and 8 CRC lines, up to 7 bits of data may be embedded that is in addition to the normal 64-bit payload. For each bit of additional data that is to be sent, a pair of predefined bits may be selected for inverting-one pair for each additional bit of data that is to be encoded. Then, the DQ data that is transferred to the receiver is the modified version, where the corresponding pairs have been inverted based on their corresponding additional bit of data. The CRC values are calculated based on the original DQ data and set with the modified DQ data to the receiver.

An example system is shown in FIG. 3, where the DQ/CRC encoder 320 may invert predefined bit pair locations, where the inversion is based the corresponding bit of additional data that is to be encoded in the corresponding pair. Up to 7 bits of additional data (ADDITIONALDATA[0:6]) may be encoded, each additional bit corresponding to a different predefined pair of bit positions whose values are inverted based on the additional bit of data. This encoded DQ data (Encoded DQ[0:63]) is then sent to the receiver along with corresponding computed CRC values (CRC[0:7]). However, the transmitted CRC values (CRC[0:7]) are calculated based on the original DQ data (DQ[0:63]) and not based on the encoded DQ data. In the receiver circuitry, a DQ/CRC decoder 330 decodes the received encoded DQ data and received CRC data in order to recover the original DQ data, additional data bits, and perform a CRC error check.

Starting with one bit of additional data as an example, two bit positions (i.e., a pair of bit positions) of DQ may be selected as the predefined positions related to encoding the one bit of additional data, and then, when computing the CRC values to be transmitted, the system uses an inverted value of the original DQ data at the pair of bit positions, inverted based on the one bit of additional data. For example, the system may predefine the bit positions 48 and 63 to be the pair of bit positions to use for encoding the one bit of additional data. If the additional bit to transfer is 1, the original DQ bit values at positions 48 and 63 are inverted, otherwise the original bit value is not inverted. In formulaic language:

Encoded DQ [48] = DQ DATA[48] \hat{ } Additional Data[0]
Encoded DQ [63] = DQ DATA[63] \hat{ } Additional Data[0].

This modified version of the original DQ data is then transmitted as encoded DQ data to the receiver (Encoded_DQ[0:63]).

Encoded DQ Data, 48/63 Pair Inverted

| | | | | | | | | |
|---|---|---|---|---|---|---|---|---|
| DQ0 | 0 | 1 | 2 | 3 | 4 | 5 | 6 | 7 |
| DQ1 | 8 | 9 | 10 | 11 | 12 | 13 | 14 | 15 |
| DQ2 | 16 | 17 | 18 | 19 | 20 | 21 | 22 | 23 |
| DQ3 | 24 | 25 | 26 | 27 | 28 | 29 | 30 | 31 |
| DQ4 | 32 | 33 | 34 | 35 | 36 | 37 | 38 | 39 |
| DQ5 | 40 | 41 | 42 | 43 | 44 | 45 | 46 | 47 |
| DQ6 | 48* | 49 | 50 | 51 | 52 | 53 | 54 | 55 |
| DQ7 | 56 | 57 | 58 | 59 | 60 | 61 | 62 | 63* |

Importantly, the encoder (e.g., DQ/CRC encoder 320) calculates the CRC values to be transmitted based on the original DQ bit values and not on the encoded DQ data. The encoded DQ data is then transmitted to the receiver along with the computed CRC values.

On the receiver side, a DQ/CRC decoder 330 computes two CRC values for the received encoded DQ data, each on different versions of the received encoded DQ data. One version is computed on the originally received DQ data and the other is on a modified version where the received DQ data is inverted at the corresponding pair of bit positions. Formulaically, the two different version of the received DQ data are

RX_DQ0 = RX ENCODED DQ[0:63]
RX_DQ1 = RX ENCODED DQ[0:63], where DQ[48] = DQ[48] \hat{ } 1, DQ[63] = DQ[63] \hat{ } 1

Then, the two CRC values (CRC0 and CRC1) are calculated based on this modified version:

C0_CRC[0:7] = CRC COMPUTE { RX_DQ0[0:63] }
C1_CRC[0:7] = CRC COMPUTE { RX_DQ1[0:63] }

The computed CRC values are compared to the received CRC value (RXCRC[0:7]) to check for a match, and depending on which one matches, the DQ/CRC Decoder 330 may determine the value of the addition bit. For example, if the first CRC value matches, the additional bit is 0, the received data corresponds to RX DATA DQ0, and there is no error. If the second CRC value matches, the additional bit is 1, the received data corresponds to RX DATA DQ1, and there is no error. If there are two matches or no matches, this indicates a CRC error. Programmatically, this may be written as:

```
IF (RXCRC[0:7] == C0_CRC[0:7] ) :
    RXDATA = RX DATA DQO[0:63]
    ADDITIONAL DATA BIT = 0
    CRC_ERROR = 0
ELSE IF ( RXCRC[0:7] == C1_CRC[0:7] ) :
  RXDATA = RX DATA DQ1[0:63]
  ADDITIONAL DATA BIT = 1
  CRC_ERROR = 0
ELSE:
  CRC_ERROR = 1
END IF
```

As shown in FIG. 5, transmitting a 64 bit data word with one additional bit of data transmitted in the CRC encoded manner discussed above, the error detection efficiency is slightly reduced compared to a normal, unmodified or “original” CRC scheme (whose error detection efficiency is shown, e.g., in FIG. 1), but error detection remains robust while providing the ability to transfer additional data. With an additional 1 bit of data transferred, the error detection efficiency remains at 100% for odd bit failures and has dropped down by ˜0.8% for even bit failures. As should be understood, the more additional data bits that are transferred in this manner, the error detection efficiency will reduce. In FIG. 5, the error detection efficiency for the unmodified CRC scheme is plotted on line 501 while the error detection efficiency for the modified CRC scheme to send an additional bit of data is plotted on line 502.

As should be understood, the example above may then be expanded to additional bits of data, where each additional bit corresponds to a different, unique pair of bit positions that will be inverted based on the corresponding additional bit. While any set of different, unique pairs may be used, an example of predefined bit position pairs that correspond to their additional bit (A[0:7]) is shown below:

A0 = DQ[48], DQ[63]
A1 = DQ[49], DQ[62]
A2 = DQ[50], DQ[61]
A3 = DQ[51], DQ[60]
A4 = DQ[12], DQ[46]
A5 = DQ[13], DQ[45]
A6 = DQ[14], DQ[44]
A7 = DQ[15], DQ[43]

On the transmission side, the DQ/CRC encoder 320 further modifies the original DQ data by inverting, for each additional bit to be transmitted, the corresponding pair of bits based on the value of the additional bit to be transmitted. The modified version of the original DQ data is then transmitted as encoded DQ data to the receiver (Encoded_DQ[0:63]).

On the receiver circuitry side, for each additional bit A[0:7], the DQ/CRC decoder 330 computes two CRC values for the received encoded DQ data, inverting the corresponding pair of bit locations based on the corresponding additional bit value. So, as another example, for bit A6, the RX_DQ1 will be (while RX_DQ0 is the as-received encoded transmission, as above):

$$RX\_DQ1 = RX ENCODED DQ [ 0 : 63 ] , where DQ [ 14 ] = DQ [ 14 ] ⋀ 1 , DQ [ 44 ] = DQ [ 44 ] ⋀ 1$$

The computed CRC values are compared to the received CRC value (RXCRC[0:7]) to check for a match, and depending on which one of RX_DQ0 or RX_DQ1 matches, the DQ/CRC Decoder 330 may determine the value of the addition bit. For example, if the first CRC value matches, the additional bit is 0, the received data corresponds to RX DATA DQ0, and there is no error. If the second CRC value matches, the additional bit is 1, the received data corresponds to RX DATA DQ1, and there is no error. If there are two matches or no matches, this indicates a CRC error.

An example of how the receiver circuitry sweeps across all the values of additional bits A[0:6] over the entire width of the data word (e.g., from 0 to 64):

Sweep across all the values of Additional bits, A[0:6] i.e. from 0 to 64.

```
Count = 0
Error = 0
For Loop i from 0 to 64:
  AV = i
  DQ[48] = RXDQ[48] \hat{ } AV0
  DQ[63] = RXDQ[63] \hat{ } AV0
  DQ[49] = RXDQ[49] \hat{ } AV1
  DQ[62] = RXDQ[62] \hat{ } AV1
  DQ[50] = RXDQ[50] \hat{ } AV2
  DQ[61] = RXDQ[61] \hat{ } AV2
  DQ[51] = RXDQ[51] \hat{ } AV3
  DQ[60] = RXDQ[60] \hat{ } AV3
  DQ[12] = RXDQ[12] \hat{ } AV4
  DQ[46] = RXDQ[46] \hat{ } AV4
  DQ[13] = RXDQ[13] \hat{ } AV5
  DQ[45] = RXDQ[45] \hat{ } AV5
  DQ[14] = RXDQ[14] \hat{ } AV6
  DQ[44] = RXDQ[44] \hat{ } AV6
  DQ[15] = RXDQ[15] \hat{ } AV7
  DQ[43] = RXDQ[43] \hat{ } AV7
  CRC[0:7] = CRC COMPUTE { DQ[0:63] }
  If( CRC[0:7] == RXCRC[0:7]):
    RXDATA[0:63] : DQ[0:63]
    A[0:6] = i
    Count = Count + 1
  End If
  DQ[48] = RXDQ[48] \hat{ } AV0
  DQ[63] = RXDQ[63] \hat{ } AV0
  DQ[49] = RXDQ[49] \hat{ } AV1
  DQ[62] = RXDQ[62] \hat{ } AV1
  DQ[50] = RXDQ[50] \hat{ } AV2
  DQ[61] = RXDQ[61] \hat{ } AV2
  DQ[51] = RXDQ[51] \hat{ } AV3
  DQ[60] = RXDQ[60] \hat{ } AV3
  DQ[12] = RXDQ[12] \hat{ } AV4
  DQ[46] = RXDQ[46] \hat{ } AV4
  DQ[13] = RXDQ[13] \hat{ } AV5
  DQ[45] = RXDQ[45] \hat{ } AV5
  DQ[14] = RXDQ[14] \hat{ } AV6
  DQ[44] = RXDQ[44] \hat{ } AV6
  DQ[15] = RXDQ[15] \hat{ } AV7
  DQ[43] = RXDQ[43] \hat{ } AV7
End of For loop
If (Count==1):
  Receiver Data = RXDATA[0:63]
  Additional Data[0:6] = A[0:6]
  Error = 0
Else:
  Error = 1
End If
```

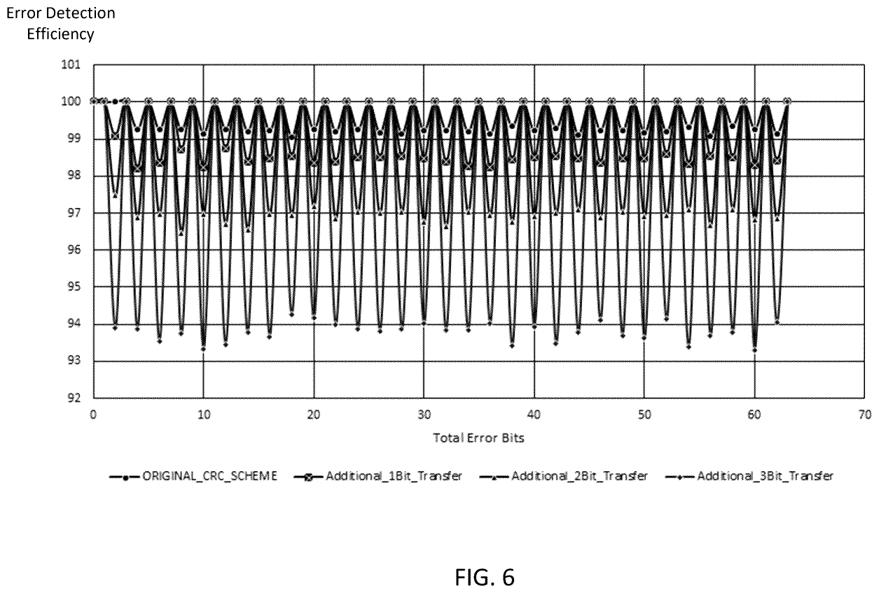

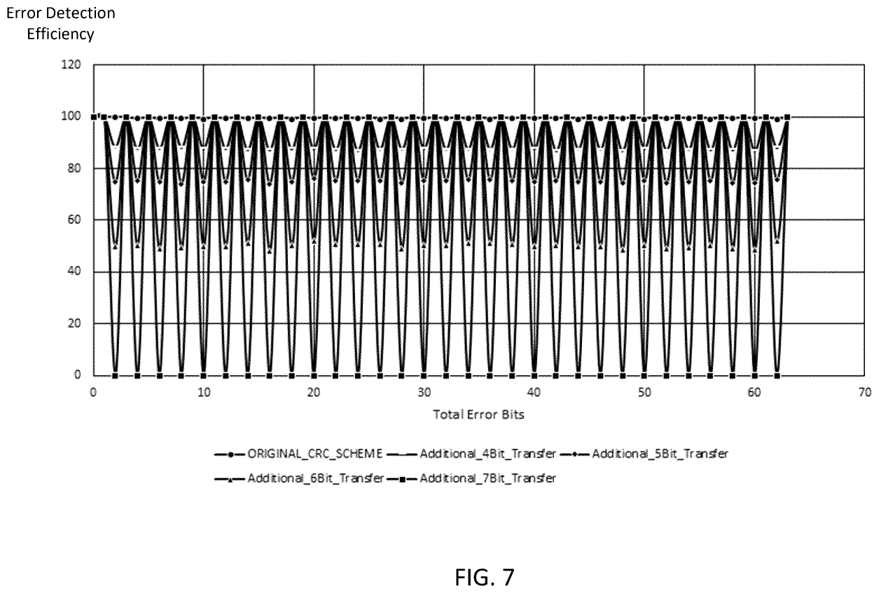

With the above scheme, the system may communicate 64-bit DQ data and an additional 7 bits of data along with CRC error signature. This provides both robots CRC error detection functionality while also allowing for more data to be transmitted over the same set of lines. As should be understood, the additional data bits may contain the additional information needed for supporting functionalities like DBI, DM, parity, address, etc. while maintaining robust error detection efficiency. As noted earlier, as the quantity of additional data bits increases, the error detection efficiency takes a further hit, so users may select an optimum trade off in error detection efficiency and extent of additional bit transfer. FIGS. 6 and 7 shows the impact to error detection efficiency as further additional bits are embedded in this manner.

Across all additional transfer of bits, odd bit position errors may still be detected with 100% efficiency. The even bit position errors have a lower efficiency as the number of additional bits to transfer increases.

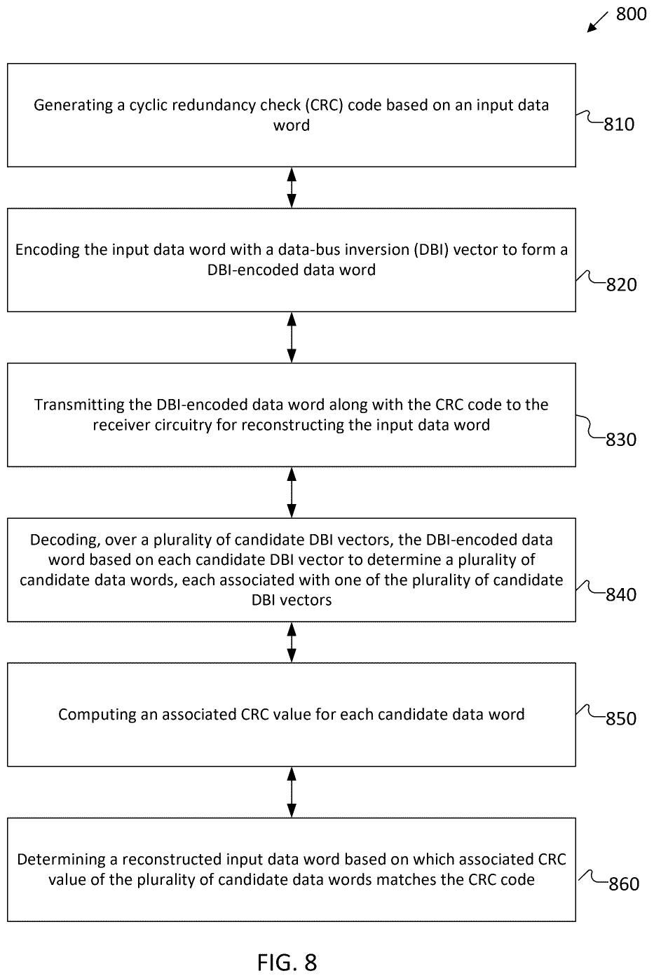

FIG. 8 shows a method 800 for communicating data with error detection, wherein the method includes, in 810, generating a cyclic redundancy check (CRC) code based on an input data word. Method 800 further includes, in 820, encoding the input data word with a data-bus inversion (DBI) vector to form a DBI-encoded data word. Method 800 further includes, in 830, transmitting the DBI-encoded data word along with the CRC code to the receiver circuitry for reconstructing the input data word. Method 800 further includes, in 840, decoding, over a plurality of candidate DBI vectors, the DBI-encoded data word based on each candidate DBI vector to determine a plurality of candidate data words, each associated with one of the plurality of candidate DBI vectors. Method 800 further includes, in 850, computing an associated CRC value for each candidate data word. Method 800 further includes, in 860, determining a reconstructed input data word based on which associated CRC value of the plurality of candidate data words matches the CRC code.

In the following, various examples are provided that may include one or more aspects described with reference to the CRC and DBI schemes discussed above and/or any of FIGS. 1-8.

Example 1 is a device including a transmitter circuitry and a receiver circuitry, the transmitter circuitry configured to generate a cyclic redundancy check (CRC) code for an input data word. The transmitter circuitry is also configured to encode the input data word with a data-bus inversion (DBI) vector to form a DBI-encoded data word. The transmitter circuitry is also configured to transmit the DBI-encoded data word along with the CRC code to the receiver circuitry for reconstructing the input data word, wherein the receiver circuitry is configured to decode, over a plurality of candidate DBI vectors, the DBI-encoded data word based on each candidate DBI vector to determine a plurality of candidate data words, each associated with one of the plurality of candidate DBI vectors. The receiver circuitry is also configured to compute an associated CRC value for each candidate data word. The receiver circuitry is also configured to determine a reconstructed input data word based on which associated CRC value of the plurality of candidate data words matches the CRC code.

Example 2 is the device of example 1, wherein the receiver circuitry is further configured to determine, based on a disambiguation rule associated with the CRC code, the reconstructed input data word from among multiple matching candidate data words of the plurality of candidate data words that match the CRC code.

Example 3 is the device of example 2, wherein the disambiguation rule includes a predetermined modification of a designated bit of the input data word, wherein the transmitter circuitry is configured to modify the input data word with the predetermined modification, wherein the CRC code is based on the predetermined modification.

Example 4 is the device of example 2, wherein the disambiguation rule includes a selection symbol included in the CRC code, wherein the selection symbol indicates which one to select of the multiple matching candidate data words.

Example 5 is the device of example 3, wherein the predetermined modification includes an inverting of the designated bit.

Example 6 is the device of any one of examples 1 to 5, wherein the device includes a data interface for a memory.

Example 7 is the device of any one of examples 1 to 6, wherein the receiver circuitry configured to decode, over the plurality of candidate DBI vectors includes the receiver circuitry configured to sweep over 256 different ones of the plurality of candidate DBI vectors.

Example 8 is the device of any one of examples 1 to 7, wherein the transmitter circuitry is configured to refrain from transmitting the DBI vector to the receiver circuitry.

Example 9 is the device of any one of examples 1 to 8, wherein the receiver circuitry configured to determine the reconstructed input data word includes the receiver circuitry configured to determine the reconstructed input data word without receiving the DBI vector.

Example 10 is the device of any one of examples 1 to 9, wherein the transmitter circuitry is configured to transmit the DBI-encoded data word along with the CRC code on a same set of pins to the receiver circuitry for reconstructing the input data word.

Example 11 is a device including an array of data inputs to receive a representation of a data word encoded according to a data-bus inversion (DBI) scheme. The device also includes an auxiliary input to receive a control code including a cyclic redundancy check (CRC) generated over the data word. The device also includes processing circuitry configured to de-invert, based a plurality of candidate DBI indications, the representation of the data word into a plurality of candidate data words, each candidate data word associated with a corresponding one of the plurality of candidate DBI indications. The processing circuitry is also configured to compute a corresponding CRC value for each of the plurality of candidate data words. The processing circuitry is also configured to determine which of the plurality of candidate data words is the data word based on whether the corresponding CRC value is a match to the control code.

Example 12 is the device of example 11, wherein the processing circuitry is further configured to, based on a plurality of matches in the plurality of candidate data words in which the corresponding CRC value matches the control code, resolve among the plurality of matches based on a disambiguation indicator conveyed in the control code or by a predetermined rule for modifying one or more bits of the control code.

Example 13 is the device of example 12, wherein the disambiguation indicator includes an inversion to a fixed bit of the control code.

Example 14 is a system including a transmitter circuitry and a receiver circuitry, wherein the transmitter circuitry is configured to obtain a data word and an additional data bit to be embedded in the data word. The transmitter circuitry is also configured to generate a modified data word based on a value inversion at a pair of bit positions of the data word, wherein the value inversion is based on a bit value of the additional data bit, wherein the modified data word is a same bit-length as the data word. The transmitter circuitry is also configured to generate error-detection information based on the data word. The transmitter circuitry is also configured to transmit the error-detection information and the modified data word to the receiver circuitry, wherein the receiver circuitry is configured to receive the modified data word and the error-detection information. The receiver circuitry is also configured to compute a first error-detection value based on the modified data word. The receiver circuitry is also configured to generate a modified received data word by inverting each value at each of the pair of bit positions in the modified data word. The receiver circuitry is also configured to compute a second error-detection value based on the modified received data word. The receiver circuitry is also configured to determine a bit value of the additional data bit based on the first error-detection value, the second error-detection value, and the error-detection information.

Example 15 is the system of example 14, wherein the receiver circuitry configured to determine the bit value of the additional data bit includes comparing the first error-detection value and the second error-detection value to the error-detection information.

Example 16 is the system of any one of examples 14 to 15, wherein the error-detection information includes a cyclic redundancy check (CRC) value.

Example 17 is the system of any one of examples 14 to 16, wherein the pair of bit positions are predefined positions within the data word.

Example 18 is the system of any one of examples 14 to 17, wherein the data word is a 64-bit data word, wherein the pair of bit positions are bit positions 48 and 63.

Example 19 is the system of any one of examples 14 to 18, wherein the transmitter circuitry is further configured to embed a plurality of additional data bits in the data word, each additional data bit being encoded by inverting values at a respective different pair of bit positions.

Example 20 is the system of example 19, wherein the plurality of additional data bits includes up to seven additional data bits, each corresponding to one of seven different pairs of bit positions.

Example 21 is the system of any one of examples 19 to 20, wherein the receiver circuitry is configured to, for each additional data bit of the plurality of additional data bits: generate a modified candidate data word for each of a plurality of candidate bit pair positions, each candidate bit pair positions corresponding to one of the respective different pair of bit positions, by inverting values of the data word at the candidate bit pair positions; compute a corresponding error-detection value for the modified candidate data word for each of the plurality of candidate bit pair positions; and determine the additional data bit based on which corresponding error-detection value of the modified candidate data word for each of the plurality of candidate bit pair positions matches the error-detection information.

Example 22 is the system of any one of examples 19 to 21, wherein the receiver circuitry is further configured to determine an error condition when more than one corresponding error-detection value of the modified candidate data word for each of the plurality of candidate bit pair positions matches the error-detection information.

Example 23 is the system of any one of examples 14 to 22, wherein the system includes a double data rate (DDR) memory interface.

Example 24 is the system of any one of examples 14 to 23, wherein the system includes a high bandwidth memory (HBM) interface.

Example 25 is the system of any one of examples 14 to 24, wherein the transmitter circuitry and the receiver circuitry are implemented within an integrated circuit.

Example 26 is the system of any one of examples 14 to 25, wherein the transmitter circuitry and the receiver circuitry are coupled by a first set of physical data lines, each corresponding to a bit of the data word, wherein the transmitter circuitry and the receiver circuitry are further coupled by a second set of physical data lines, each corresponding to a bit of the error-detection information.

Example 27 is the system of any one of examples 14 to 26, wherein the transmitter circuitry and the receiver circuitry are implemented as respective modules within a memory controller.

Example 28 is the system of any one of examples 14 to 27, wherein the transmitter circuitry is configured to select the pair of bit positions based on a statistical analysis of error detection coverage for the data word.

Example 29 is the system of any one of examples 14 to 28, wherein the receiver circuitry is further configured to determine an error condition when neither the first error-detection value nor the second error-detection value matches the error-detection information.

Example 30 is a method including generating a cyclic redundancy check (CRC) code for an input data word. The method also includes encoding the input data word with a data-bus inversion (DBI) vector to form a DBI-encoded data word. The method also includes transmitting the DBI-encoded data word along with the CRC code to a receiver for reconstructing the input data word. The method further includes decoding, over a plurality of candidate DBI vectors, the DBI-encoded data word based on each candidate DBI vector to determine a plurality of candidate data words, each associated with one of the plurality of candidate DBI vectors. The method also includes computing an associated CRC value for each candidate data word. The method also includes determining a reconstructed input data word based on which associated CRC value of the plurality of candidate data words matches the CRC code.

Example 31 is the method of example 30, the method further including determining, based on a disambiguation rule associated with the CRC code, the reconstructed input data word from among multiple matching candidate data words of the plurality of candidate data words that match the CRC code.

Example 32 is the method of example 31, wherein the disambiguation rule includes a predetermined modification of a designated bit of the input data word, wherein the method further includes modifying the input data word with the predetermined modification, wherein the CRC code is based on the predetermined modification.

Example 33 is the method of example 31, wherein the disambiguation rule includes a selection symbol included in the CRC code, wherein the selection symbol indicates which one to select of the multiple matching candidate data words.

Example 34 is the method of example 32, wherein the predetermined modification includes an inverting of the designated bit.

Example 35 is the method of any one of examples 30 to 34, wherein the method operates as a data interface for a memory.

Example 36 is the method of any one of examples 30 to 35, wherein the decoding over the plurality of candidate DBI vectors includes sweeping over 256 different ones of the plurality of candidate DBI vectors.

Example 37 is the method of any one of examples 30 to 36, the method further including refraining from transmitting the DBI vector to the receiver circuitry.

Example 38 is the method of any one of examples 30 to 37, wherein the determining the reconstructed input data word includes determining the reconstructed input data word without receiving the DBI vector.

Example 39 is the method of any one of examples 30 to 38, the method further including transmitting the DBI-encoded data word along with the CRC code on a same set of pins to the receiver circuitry for reconstructing the input data word.

Example 40 is a method including receiving (via an array of data inputs) a representation of a data word encoded according to a data-bus inversion (DBI) scheme. The method also includes receiving (at an auxiliary input) a control code including a cyclic redundancy check (CRC) generated over the data word. The method also includes de-inverting, based a plurality of candidate DBI indications, the representation of the data word into a plurality of candidate data words, each candidate data word associated with a corresponding one of the plurality of candidate DBI indications. The method also includes computing a corresponding CRC value for each of the plurality of candidate data words. The method also includes determining which of the plurality of candidate data words is the data word based on whether the corresponding CRC value is a match to the control code.

Example 41 is the method of example 40, wherein the method further includes resolving, based on a plurality of matches in the plurality of candidate data words in which the corresponding CRC value matches the control code, among the plurality of matches based on a disambiguation indicator conveyed in the control code or by a predetermined rule for modifying one or more bits of the control code.

Example 42 is the method of example 41, wherein the disambiguation indicator includes an inversion to a fixed bit of the control code.

Example 43 is a method including obtaining a data word and an additional data bit to be embedded in the data word. The method also includes generating a modified data word based on a value inversion at a pair of bit positions of the data word, wherein the value inversion is based on a bit value of the additional data bit, wherein the modified data word is a same bit-length as the data word. The method also includes generating error-detection information based on the data word. The method further includes transmitting the error-detection information and the modified data word to a receiver circuitry. The method further includes receiving the modified data word and the error-detection information. The method further includes computing a first error-detection value based on the modified data word. The method further includes generating a modified received data word by inverting each value at each of the pair of bit positions in the modified data word. The method further includes computing a second error-detection value based on the modified received data word. The method also includes determining a bit value of the additional data bit based on the first error-detection value, the second error-detection value, and the error-detection information.

Example 44 is the method of example 43, wherein the determining the bit value of the additional data bit includes comparing the first error-detection value and the second error-detection value to the error-detection information.

Example 45 is the method of any one of examples 43 to 44, wherein the error-detection information includes a cyclic redundancy check (CRC) value.

Example 46 is the method of any one of examples 43 to 45, wherein the pair of bit positions are predefined positions within the data word.

Example 47 is the method of any one of examples 43 to 46, wherein the data word is a 64-bit data word, wherein the pair of bit positions are bit positions 48 and 63.

Example 48 is the method of any one of examples 43 to 47, wherein the method further includes embedding a plurality of additional data bits in the data word, each additional data bit being encoded by inverting values at a respective different pair of bit positions.

Example 49 is the method of example 48, wherein the plurality of additional data bits includes up to seven additional data bits, each corresponding to one of seven different pairs of bit positions.

Example 50 is the method of any one of examples 48 to 49, wherein the method further includes, for each additional data bit of the plurality of additional data bits: generating a modified candidate data word for each of a plurality of candidate bit pair positions, each candidate bit pair positions corresponding to one of the respective different pair of bit positions, by inverting values of the data word at the candidate bit pair positions; computing a corresponding error-detection value for the modified candidate data word for each of the plurality of candidate bit pair positions; and determining the additional data bit based on which corresponding error-detection value of the modified candidate data word for each of the plurality of candidate bit pair positions matches the error-detection information.

Example 51 is the method of any one of examples 48 to 50, wherein the method further includes determining an error condition when more than one corresponding error-detection value of the modified candidate data word for each of the plurality of candidate bit pair positions matches the error-detection information.

Example 52 is the method of any one of examples 43 to 51, wherein the method is for a double data rate (DDR) memory interface.

Example 53 is the method of any one of examples 43 to 52, wherein the method is for a high bandwidth memory (HBM) interface.

Example 54 is the method of any one of examples 43 to 53, wherein the method is for transmitter circuitry and receiver circuitry implemented within an integrated circuit.

Example 55 is the method of any one of examples 43 to 54, wherein the transmitter circuitry and the receiver circuitry are coupled by a first set of physical data lines, each corresponding to a bit of the data word, wherein the transmitter circuitry and the receiver circuitry are further coupled by a second set of physical data lines, each corresponding to a bit of the error-detection information.

Example 56 is the method of any one of examples 43 to 55, wherein the transmitter circuitry and the receiver circuitry operate as respective modules within a memory controller.

Example 57 is the method of any one of examples 43 to 56, wherein the method further includes selecting the pair of bit positions based on a statistical analysis of error detection coverage for the data word.

Example 58 is the method of any one of examples 43 to 57, wherein the method further includes determining an error condition when neither the first error-detection value nor the second error-detection value matches the error-detection information.

Example 59 is a non-transitory computer-readable medium including instructions that when executed by one or more processors cause the one or more processors to: generate a cyclic redundancy check (CRC) code for an input data word; encode the input data word with a data-bus inversion (DBI) vector to form a DBI-encoded data word; transmit the DBI-encoded data word along with the CRC code to a receiver circuitry for reconstructing the input data word; decode, at the receiver circuitry, over a plurality of candidate DBI vectors, the DBI-encoded data word based on each candidate DBI vector to determine a plurality of candidate data words, each associated with one of the plurality of candidate DBI vectors; and compute an associated CRC value for each candidate data word; determine a reconstructed input data word based on which associated CRC value of the plurality of candidate data words matches the CRC code.

Example 60 is the non-transitory computer-readable medium of example 59, wherein instructions further cause the one or more processors to determine, based on a disambiguation rule associated with the CRC code, the reconstructed input data word from among multiple matching candidate data words of the plurality of candidate data words that match the CRC code.

Example 61 is the non-transitory computer-readable medium of example 60, wherein the disambiguation rule includes a predetermined modification of a designated bit of the input data word, wherein instructions further cause the one or more processors to modify the input data word with the predetermined modification, wherein the CRC code is based on the predetermined modification.

Example 62 is the non-transitory computer-readable medium of example 60, wherein the disambiguation rule includes a selection symbol included in the CRC code, wherein the selection symbol indicates which one to select of the multiple matching candidate data words.

Example 63 is the non-transitory computer-readable medium of example 61, wherein the predetermined modification includes an inverting of the designated bit.

Example 64 is the non-transitory computer-readable medium of any one of examples 59 to 63, wherein the device includes a data interface for a memory.

Example 65 is the non-transitory computer-readable medium of any one of examples 59 to 64, wherein the instructions that cause the one or more processors to decode over the plurality of candidate DBI vectors includes that the instructions further cause the one or more processors to sweep over 256 different ones of the plurality of candidate DBI vectors.

Example 66 is the non-transitory computer-readable medium of any one of examples 59 to 65, wherein instructions further cause the one or more processors to refrain from transmitting the DBI vector to the receiver circuitry.

Example 67 is the non-transitory computer-readable medium of any one of examples 59 to 66, wherein the instructions that cause the one or more processors to determine the reconstructed input data word includes that instructions further cause the one or more processors to the receiver circuitry configured to determine the reconstructed input data word without receiving the DBI vector.

Example 68 is the non-transitory computer-readable medium of any one of examples 59 to 67, wherein the instructions further cause the one or more processors to transmit the DBI-encoded data word along with the CRC code on a same set of pins to the receiver circuitry for reconstructing the input data word.

Example 69 is a non-transitory computer-readable medium including instructions that when executed by one or more processors cause the one or more processors to: receive (e.g., via an array of data inputs) a representation of a data word encoded according to a data-bus inversion (DBI) scheme. The instructions also cause the one or more processors to (e.g., via an auxiliary input) receive a control code including a cyclic redundancy check (CRC) generated over the data word. The instructions also cause the one or more processors to de-invert, based a plurality of candidate DBI indications, the representation of the data word into a plurality of candidate data words, each candidate data word associated with a corresponding one of the plurality of candidate DBI indications. The instructions also cause the one or more processors to compute a corresponding CRC value for each of the plurality of candidate data words. The instructions also cause the one or more processors to determine which of the plurality of candidate data words is the data word based on whether the corresponding CRC value is a match to the control code.

Example 70 is the non-transitory computer-readable medium of example 69, wherein the instructions also cause the one or more processors to, based on a plurality of matches in the plurality of candidate data words in which the corresponding CRC value matches the control code, resolve among the plurality of matches based on a disambiguation indicator conveyed in the control code or by a predetermined rule for modifying one or more bits of the control code.

Example 71 is the non-transitory computer-readable medium of example 70, wherein the disambiguation indicator includes an inversion to a fixed bit of the control code.

Example 72 is a non-transitory computer-readable medium including instructions that when executed by one or more processors cause the one or more processors to obtain a data word and an additional data bit to be embedded in the data word. The instructions also cause the one or more processors to generate a modified data word based on a value inversion at a pair of bit positions of the data word, wherein the value inversion is based on a bit value of the additional data bit, wherein the modified data word is a same bit-length as the data word. The instructions also cause the one or more processors to generate error-detection information based on the data word. The instructions also cause the one or more processors to transmit the error-detection information and the modified data word to receiver circuitry. The instructions also cause the one or more processors to receive the modified data word and the error-detection information. The instructions also cause the one or more processors to compute a first error-detection value based on the modified data word. The instructions also cause the one or more processors to generate a modified received data word by inverting each value at each of the pair of bit positions in the modified data word. The instructions also cause the one or more processors to compute a second error-detection value based on the modified received data word. The instructions also cause the one or more processors to determine a bit value of the additional data bit based on the first error-detection value, the second error-detection value, and the error-detection information.

Example 73 is the non-transitory computer-readable medium of example 72, wherein the instructions also cause the one or more processors to determine the bit value of the additional data bit includes comparing the first error-detection value and the second error-detection value to the error-detection information.

Example 74 is the non-transitory computer-readable medium of any one of examples 72 to 73, wherein the error-detection information includes a cyclic redundancy check (CRC) value.

Example 75 is the non-transitory computer-readable medium of any one of examples 72 to 74, wherein the pair of bit positions are predefined positions within the data word.

Example 76 is the non-transitory computer-readable medium of any one of examples 72 to 75, wherein the data word is a 64-bit data word, wherein the pair of bit positions are bit positions 48 and 63.

Example 77 is the non-transitory computer-readable medium of any one of examples 72 to 76, wherein the instructions also cause the one or more processors to embed a plurality of additional data bits in the data word, each additional data bit being encoded by inverting values at a respective different pair of bit positions.

Example 78 is the non-transitory computer-readable medium of example 77, wherein the plurality of additional data bits includes up to seven additional data bits, each corresponding to one of seven different pairs of bit positions.

Example 79 is the non-transitory computer-readable medium of any one of examples 77 to 78, wherein the instructions also cause the one or more processors to, for each additional data bit of the plurality of additional data bits: generate a modified candidate data word for each of a plurality of candidate bit pair positions, each candidate bit pair positions corresponding to one of the respective different pair of bit positions, by inverting values of the data word at the candidate bit pair positions; compute a corresponding error-detection value for the modified candidate data word for each of the plurality of candidate bit pair positions; and determine the additional data bit based on which corresponding error-detection value of the modified candidate data word for each of the plurality of candidate bit pair positions matches the error-detection information.

Example 80 is the non-transitory computer-readable medium of any one of examples 77 to 79, wherein the instructions also cause the one or more processors to determine an error condition when more than one corresponding error-detection value of the modified candidate data word for each of the plurality of candidate bit pair positions matches the error-detection information.

Example 81 is the non-transitory computer-readable medium of any one of examples 72 to 80, wherein the non-transitory computer-readable medium includes a double data rate (DDR) memory interface.

Example 82 is the non-transitory computer-readable medium of any one of examples 72 to 81, wherein the non-transitory computer-readable medium includes a high bandwidth memory (HBM) interface.

Example 83 is the non-transitory computer-readable medium of any one of examples 72 to 82, wherein the non-transitory computer-readable medium is implemented within an integrated circuit.

Example 84 is the non-transitory computer-readable medium of any one of examples 72 to 83, wherein the non-transitory computer-readable medium is for a transmitter circuitry coupled to a receiver circuitry by a first set of physical data lines, each corresponding to a bit of the data word, wherein the transmitter circuitry and the receiver circuitry are further coupled by a second set of physical data lines, each corresponding to a bit of the error-detection information.

Example 85 is the non-transitory computer-readable medium of any one of examples 72 to 84, wherein the non-transitory computer-readable medium includes respective modules within a memory controller to operate the transmitter circuitry and the receiver circuitry.

Example 86 is the non-transitory computer-readable medium of any one of examples 72 to 85, wherein the instructions also cause the one or more processors to select the pair of bit positions based on a statistical analysis of error detection coverage for the data word.

Example 87 is the non-transitory computer-readable medium of any one of examples 72 to 86, wherein the receiver circuitry is further configured to determine an error condition when neither the first error-detection value nor the second error-detection value matches the error-detection information.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising:
a transmitter circuitry and a receiver circuitry, the transmitter circuitry configured to:
generate a cyclic redundancy check (CRC) code based on an input data word;
encode the input data word with a data-bus inversion (DBI) vector to form a DBI-encoded data word; and
transmit the DBI-encoded data word along with the CRC code to the receiver circuitry for reconstructing the input data word, wherein the receiver circuitry is configured to:
decode, over a plurality of candidate DBI vectors, the DBI-encoded data word based on each candidate DBI vector to determine a plurality of candidate data words, each associated with one of the plurality of candidate DBI vectors;
compute an associated CRC value for each candidate data word; and
determine a reconstructed input data word based on which associated CRC value of the plurality of candidate data words matches the CRC code.

2. The device of claim 1, wherein the receiver circuitry is further configured to determine, based on a disambiguation rule associated with the CRC code, the reconstructed input data word from among multiple matching candidate data words of the plurality of candidate data words that match the CRC code.

3. The device of claim 2, wherein the disambiguation rule comprises a predetermined modification of a designated bit of the input data word, wherein the transmitter circuitry is configured to modify the input data word with the predetermined modification, wherein the CRC code is based on the predetermined modification.

4. The device of claim 2, wherein the disambiguation rule comprises a selection symbol included in the CRC code, wherein the selection symbol indicates which one to select of the multiple matching candidate data words.

5. The device of claim 3, wherein the predetermined modification comprises an inverting of the designated bit.

6. The device of claim 1, wherein the device comprises a data interface for a memory.

7. The device of claim 1, wherein the receiver circuitry configured to decode, over the plurality of candidate DBI vectors comprises the receiver circuitry configured to sweep over different ones of the plurality of candidate DBI vectors.

8. The device of claim 1, wherein the transmitter circuitry is configured to refrain from transmitting the DBI vector to the receiver circuitry.

9. The device of claim 1, wherein the receiver circuitry configured to determine the reconstructed input data word comprises the receiver circuitry configured to determine the reconstructed input data word without receiving the DBI vector.

10. The device of claim 1, wherein the transmitter circuitry is configured to transmit the DBI-encoded data word along with the CRC code on a same set of pins to the receiver circuitry for reconstructing the input data word.

11. An apparatus comprising:
an array of data inputs to receive a representation of a data word encoded according to a data-bus inversion (DBI) scheme;
an auxiliary input to receive a control code comprising a cyclic redundancy check (CRC) generated over the data word; and
processing circuitry configured to:
de-invert, based a plurality of candidate DBI indications, the representation of the data word into a plurality of candidate data words, each candidate data word associated with a corresponding one of the plurality of candidate DBI indications;
compute a corresponding CRC value for each of the plurality of candidate data words; and
determine which of the plurality of candidate data words is the data word based on whether the corresponding CRC value is a match to the control code.

12. The apparatus of claim 11, wherein the processing circuitry is further configured to, based on a plurality of matches in the plurality of candidate data words in which the corresponding CRC value matches the control code, resolve among the plurality of matches based on a disambiguation indicator conveyed in the control code or by a predetermined rule for modifying one or more bits of the control code.

13. The apparatus of claim 12, wherein the disambiguation indicator comprises an inversion to a fixed bit of the control code.

14. A system comprising:
a transmitter circuitry and a receiver circuitry, wherein the transmitter circuitry is configured to:
obtain a data word and an additional data bit to be embedded in the data word;
generate a modified data word based on a value inversion at a pair of bit positions of the data word, wherein the value inversion is based on a bit value of the additional data bit, wherein the modified data word is a same bit-length as the data word;
generate error-detection information based on the data word; and
transmit the error-detection information and the modified data word to the receiver circuitry,
wherein the receiver circuitry is configured to:
receive the modified data word and the error-detection information;
compute a first error-detection value based on the modified data word;
generate a modified received data word by inverting each value at each of the pair of bit positions in the modified data word;
compute a second error-detection value based on the modified received data word; and
determine a bit value of the additional data bit based on the first error-detection value, the second error-detection value, and the error-detection information.

15. The system of claim 14, wherein the receiver circuitry configured to determine the bit value of the additional data bit comprises comparing the first error-detection value and the second error-detection value to the error-detection information.

16. The system of claim 14, wherein the pair of bit positions are predefined positions within the data word.

17. The system of claim 14, wherein the transmitter circuitry is further configured to embed a plurality of additional data bits in the data word, each additional data bit being encoded by inverting values at a respective different pair of bit positions.

18. The system of claim 17, wherein the receiver circuitry is configured to, for each additional data bit of the plurality of additional data bits:
generate a modified candidate data word for each of a plurality of candidate bit pair positions, each candidate bit pair positions corresponding to one of the respective different pair of bit positions, by inverting values of the data word at the candidate bit pair positions;
compute a corresponding error-detection value for the modified candidate data word for each of the plurality of candidate bit pair positions; and
determine the additional data bit based on which corresponding error-detection value of the modified candidate data word for each of the plurality of candidate bit pair positions matches the error-detection information.

19. The system of claim 18, wherein the receiver circuitry is further configured to determine an error condition when more than one corresponding error-detection value of the modified candidate data word for each of the plurality of candidate bit pair positions matches the error-detection information.

20. The system of claim 14, wherein the receiver circuitry is further configured to determine an error condition when neither the first error-detection value nor the second error-detection value matches the error-detection information.
